(19) United States
(12) Patent Application Publication
(10) Pub. No.: US 2004/0032801 A1
(43) Pub. Date: Feb. 19, 2004

(54) Method for single-button control of an optical disc drive

(76) Inventor: Yi-Chuan Pan, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/351,110

(22) Filed: Jan. 24, 2003

(30) Foreign Application Priority Data
Aug. 16, 2002 (TW) 91118621

(51) Int. Cl. G11B 7/085

(52) U.S. Cl. 369/30.36

(57) ABSTRACT

The present invention discloses a method of single-button control for switching between a tray open/close mode and a music playing function mode of an optical disc drive. The modes of the optical disc drive are switched by detection of the duration of pressing the single button. The optical disc drive enters a music playing function mode to play music when the pressed time is longer than a predetermined time and a tray open/close mode to control only the opening and closing functions of a loading tray when the pressed time is shorter than the predetermined time. Thus, the functions of controlling the loading tray and playing music are operated by single button without requiring additional buttons, even in the absence of corresponding music playing software.

### BACKGROUND OF THE INVENTION

1. Field of the Invention

The present invention relates in general to a method of single-button control for switching between a tray open/close mode and a music playing function mode of an optical disc drive. In particular, the present invention relates to a method for switching the optical disc drive between a tray open/close mode and a music playing function mode according to the duration of pressing the button even in the absence of corresponding music playing software in the computer.

2. Description of the Related Art

Optical disc drives have become important equipment for personal computers with the improvement of disk storage technology. In early days, the optical disc drive only acted as a medium for loading data, for example, a data CD-ROM read by a CD-ROM drive, comprising no other functions. Considering the cost, manufacturers only disposed a single button on the panel of the optical disc drive to control the operation of the loading tray, as for opening or closing thereof. However, when a user uses the optical disc drive to read a music CD and the operating system has no music-playing software, the disk only can read the data but not play the music.

Thus, the panel of the present optical disc drive comprises a plurality of buttons to control the operations of the loading tray and play music for the requirement of the user. Thus, the user can play a music CD in the optical disc drive using the added button to play music even in the absence of supported music-playing software in the operating system.

However, the cost and complexity of the optical disc drive is increased when the extra button is added, resulting in inconvenience and disadvantages when the extra button is added.

### SUMMARY OF THE INVENTION

The object of the present invention is thus to provide a method of single-button control for switching between a tray open/close mode and a music playing function mode of an optical disc drive. The method switches the optical disc drive between tray open/close and music playing modes according to the duration of pressing the button. Thus, the functions of controlling the loading tray and playing music are operated by single button.

In addition, the present invention provides a method of single-button control for switching between a tray open/close mode and a music playing function mode of an optical disc drive, which detects the pressed condition of the button by firmware without requiring additional hardware.

To achieve the above-mentioned object, the present invention provides a method of single-button control for switching between a tray open/close mode and a music playing function mode of an optical disc drive. First, the action of pressing a button is detected. Then, the duration of pressing the button is detected and the requested mode of the optical disc drive is switched according thereto.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 shows a flowchart of the optical disc drive in normal mode according to the embodiment of the present invention.

FIG. 2 shows a flowchart of the optical disc drive in music playing function mode according to the embodiment of the present invention.

### DETAILED DESCRIPTION OF THE INVENTION

The present invention provides a method of single-button control for switching between a tray open/close mode and a music playing function mode of an optical disc drive. According to the embodiment of the invention, the single-button is an eject button on the optical disc drive, and the invention uses firmware to determine whether the optical disc is in the tray open/close mode or the music playing function mode, wherein the tray open/close mode initiates the optical disc drive controlling the loading tray opening or closing, and the music playing function mode initiates the optical disc drive controlling the music-playing process, performing the functions of playing music, fast-forward, review, following track, and previous track.

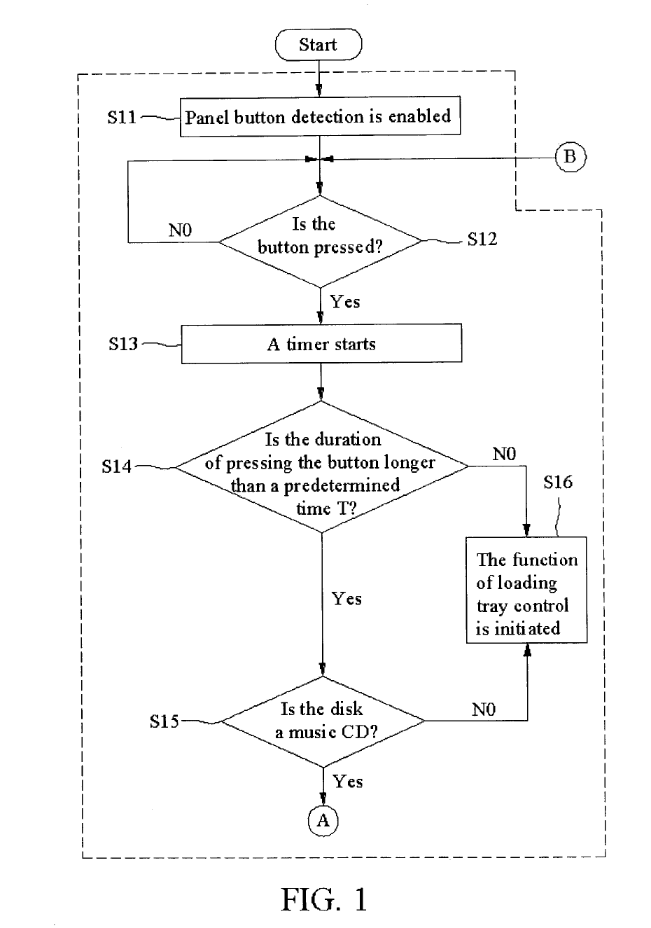

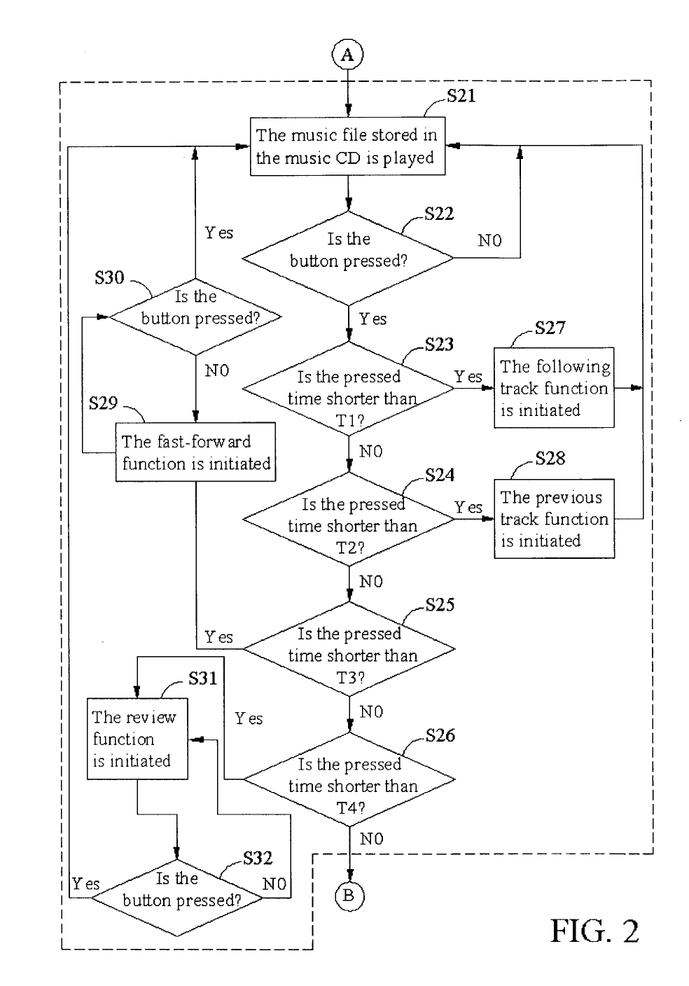

FIG. 1 shows a flowchart of the optical disc drive in tray open/close mode and FIG. 2 shows a flowchart of the optical disc drive in music playing function mode. In the present invention, a disk is inserted into the optical disc drive and the mode of the drive is switched according to the duration of pressing the single button on the optical disc drive.

In FIG. 1, initially, the optical disc drive is operated in tray open/close mode. The method comprises the following steps:

In Step S11, panel button detection is enabled.

In Step S12, the state of the button is detected, and if the button is pressed, the process goes to Step S13, if the button is not pressed, the process returns to Step S12.

In Step S13, a timer starts.

In Step S14, the duration of pressing the button is detected. If the duration of pressing the button from the timer's start to the button's release is longer than a predetermined time T, the process goes to Step S15. If the pressed time is shorter than the predetermined time T, the process goes to Step S16.

In Step S15, the type of disc in the drive is detected. If the disk is a music CD, the process goes to Step S21, initiating the music playing function mode, if not, the process goes to Step S16, staying in the tray open/close mode to execute the tray open/close control.

In Step S16, the function of loading tray control is initiated, opening or closing the loading tray, accordingly.

FIG. 2 shows a flowchart of the optical disc drive operating in music playing function mode. The method comprises the following steps:

In Step S21, the music file stored in the music CD is played.

In Step S22, the state of the button is detected for selecting the requested play mode operation type, such as fast-forward, review, following track, or previous track. If the button is pressed, the timer starts and the process goes to Step S23.

In Step S23, the duration of pressing the button from the timer's start to the button's release is detected in comparison with a predetermined time T1. If the pressed time is shorter than the predetermined time T1, the process goes to Step S27. If the pressed time is longer than the predetermined time T1, the process goes to Step S24.

In Step S24, the duration of pressing the button is detected in comparison with a predetermined time T2. If the pressed time is shorter than the predetermined time T2, the process goes to Step S28. If the pressed time is longer than the predetermined time T2, the process goes to Step S25.

In Step S25, the duration of pressing the button is detected in comparison with a predetermined time T2. If the pressed time is shorter than the predetermined time T3, the process goes to Step S29. If the pressed time is longer than the predetermined time T3, the process goes to Step S26.

In Step S26, the duration of pressing the button is detected in comparison with a predetermined time T2. If the pressed time is shorter than the predetermined time T4, the process goes to Step S31. If the pressed time is longer than the predetermined time T4, the process goes to Step S12 shown in FIG. 1 to exit play mode.

In Step S27, the following track function is initiated and the process returns to Step S21 to play the next music file.

In Step S28, the previous track function is initiated and the process returns to Step S21 to play the previous music file.

In Step S29, the fast-forward function is initiated and the process goes to Step S30.

IN Step S30, the state of the button is detected, whereby, if the button is pressed, the process goes to Step S21 to stop the fast-forward function and play, and if the button is not pressed, the process returns to Step S29 and continues the fast-forward function.

In Step S31, the review function is initiated and the process goes to Step S32.

In Step S32, the state of the button is detected, whereby if the button is pressed, the process returns to Step S21 to stop the review function and play the music, and if the button is not pressed, the process returns to Step S31 and continues the review function.

Thus, when the user inserts a music CD into the optical disc drive, the system continues to detect the state of the button. When the button is pressed, the timer starts.

When the pressed time is longer than a predetermined time T, the optical disc drive is switched, initiating a music playing function mode. In the music playing function mode, the system continues to detect the state of the button. Different durations of pressing the button initiate different operations. For example, the optical disc drive plays the following track when the pressed time is shorter than the predetermined time T1, the previous track when the pressed time is between the predetermined times T1 and T2, fast-forwards when the pressed time is between the predetermined times T2 and T3, and reviews when the pressed time is between the predetermined times T3 and T4. Here, the predetermined times T, T1, T2, T3 and T4 are positive, the predetermined time T4 is longer than the predetermined time T3, the predetermined time T3 is longer than the predetermined time T2 and the predetermined time T2 is longer than the predetermined time T1.

To exit music playing function mode, the user needs only press the button longer than the predetermined time T4 and shorter than the predetermined time T to open and close the loading tray. Thus, switching between the optical disc drive's tray open/close and music playing function modes is achieved.

In addition, when the disk in the optical disc drive is not a music CD, the optical disc drive only operates in tray open/close mode to control the opening/closing of the loading tray.

Thus, the inventive method provides the ability to switch the optical disc drive between tray open/close and music playing function modes by means of a single button and enabling firmware, without requiring an additional button, even in the absence of supported music-playing software.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method of single-button control for switching between a tray open/close mode and a music playing function mode of an optical disc drive, comprising the following steps:
(a) pressing a button; and
(b) initiating a timer to determine the duration of pressing the button and, thereby, switching between the tray open/close mode and the music playing function mode.

2. The method of single-button control for switching between a tray open/close mode and a music playing function mode of an optical disc drive as claimed in claim 1, wherein step (a) further comprises enabling a pressed button detecting function to continue detection of the button's state.

3. The method of single-button control for switching between a tray open/close mode and a music playing function mode of an optical disc drive as claimed in claim 1, wherein the button is an eject button on the optical disc drive.

4. The method of single-button control for switching between a tray open/close mode and a music playing function mode of an optical disc drive as claimed in claim 1, wherein, when the duration of pressing the button is longer than a first predetermined time T, the optical disc drive enters the music playing function mode.

5. The method of single-button control for switching between a tray open/close mode and a music play function mode of an optical disc drive as claimed in claim 4, wherein, when the duration of pressing the button is shorter than the first predetermined time T, the optical disc drive enters the tray open/close mode to control only the opening and closing functions of a loading tray.

6. The method of single-button control for switching between a tray open/close mode and a music playing function mode of an optical disc drive as claimed in claim 4, further comprising confirmation of whether a disk in the optical disc drive is a music disk.

7. The method of single-button control for switching between a tray open/close mode and a music playing function mode of an optical disc drive as claimed in claim 4, wherein a button detection is continually enabled when the optical disc drive is in the music playing function mode.

8. The method of single-button control for switching between an open/close mode and a music playing function mode of an optical disc drive as claimed in claim 7, wherein different durations of pressing the button initiate corresponding operations in the music playing function mode.

9. The method of single-button control for switching between a tray open/close mode and a music playing function mode of an optical disc drive as claimed in claim 8, wherein the corresponding operations comprise jumping to subsequent or previous tracks, fast-forwarding, and reviewing.

10. A method of single-button control for switching between a tray open/close mode and a music playing function mode of an optical disc drive, comprising the following steps:
(a) pressing a button;
(b) confirmation of the button been pressed by firmware; and
(c) initiating a timer to determine the duration of pressing the button and, thereby, switching between the tray open/close mode and the music playing function mode.

11. The method of single-button control for switching between a tray open/close mode and a music playing function mode of an optical disc drive as claimed in claim 10, wherein, when the duration of pressing the button is longer than a first predetermined time T, the optical disc drive enters the music playing function mode to play music.

12. The method of single-button control for switching between a tray open/close mode and a music playing function mode of an optical disc drive as claimed in claim 10, wherein, when the duration of pressing the button is shorter than the first predetermined time T, the optical disc drive enters the tray open/close mode to control only the opening and closing functions of a loading tray.

13. The method of single-button control for switching between a tray open/close mode and a music playing function mode of an optical disc drive as claimed in claim 10, further comprising confirming whether a disk in the optical disc drive is a music disk.

14. The method of single-button control for switching between a tray open/close mode and a music playing function mode of an optical disc drive as claimed in claim 10, wherein a button detection is enabled when the optical disc drive is operated in the music playing function mode.

15. The method of single-button control for switching between a tray open/close mode and a music playing function mode of an optical disc drive as claimed in claim 14, wherein different durations of pressing the button initiate corresponding operations in the music playing function mode.

16. The method of single-button control for switching between a tray open/close mode and a music playing function mode of an optical disc drive as claimed in claim 15, wherein the corresponding operations in the music playing function mode comprise jumping to the subsequent or previous tracks, fast-forwarding, and reviewing.

17. The method of single-button control for switching between a tray open/close mode and a music playing function mode of an optical disc drive as claimed in claim 16, wherein the fast-forward operation of the optical disc drive is stopped by pressing the button to return to play music.

18. The method of single-button control for switching between a tray open/close mode and a music playing function mode of an optical disc drive as claimed in claim 16, wherein the review operation of the optical disc drive is stopped by pressing the button to return to play music.

19. The method of single-button control for switching between a tray open/close mode and a music playing function mode of an optical disc drive as claimed in claim 16, wherein the optical disc drive returns to the tray open/close mode when the duration of pressing the button exceeds a second predetermined time.

20. The method of single-button control for switching between a tray open/close mode and a music playing function mode of an optical disc drive as claimed in claim 10, wherein the button is an eject button on the optical disc drive.
